(19) United States
(12) Patent Application Publication
(10) Pub. No.: US 2015/0120642 A1
(43) Pub. Date: Apr. 30, 2015

(54) REALTIME SNAPSHOT INDICES

(71) Applicants: Alex Gruener, Walldorf (DE); Klaus Steinbach, Walldorf (DE); Lars Spielberg, Walldorf (DE)

(72) Inventors: Lars Spielberg, St. Leon-Rot (DE); Alex Gruener, Walldorf (DE); Klaus Steinbach, Heidelberg-Kircheim (DE)

(21) Appl. No.: 14/065,300

(22) Filed: Oct. 28, 2013

(51) Int. Cl. G06F 17/30

(52) U.S. Cl. CPC G06F 17/30563; G06F 17/30424
USPC 707/602

(57) ABSTRACT

A system and method for realtime snapshot indices is presented. A query is calculated on all target data of a data warehouse, with all variable combinations, to generate a result. The result is stored in a snapshot index associated with the data warehouse. The result is recalcualated to generate a subresult, and the snapshot index is updated with the subresult. A conversion routine is generated to recalculate the subresult into a separate table, and the separate table is then recalculated by a background job to recalculate the subresult.

### TECHNICAL FIELD

The subject matter described herein relates to in-memory database systems, and more particularly to generating real-time snapshot indices using aggregated subresults.

### BACKGROUND

Calculations in conventional data warehouse systems are time consuming, with process chains running from several hours to several days. One way to address this time consumption is to use pre-calculated aggregates, which are calculated during times of low access (i.e., during the night) and presented to a user during business hours (i.e. the next morning) to report on. However, aggregates can become outdated immediately after their creation, and therefore do not represent a complete reporting of the data. Moreover, real-time processing is not possible.

Generally, many data warehousing systems are adapted to run on non aggregated data, to provide real time information. Every change on the base tables should be reflected in a changed result to the user's query. The concept “real-time” can vary, however. In computer science, real-time means to react in a predicted time frame, or within a defined time frame. That time frame can differ from case to case, but is typically set between 5 seconds and 2 to 5 minutes. But some calculations can take much longer than the time frame for real-time results. Therefore, what is needed is a technique and system to speed up process chains for processing massive amounts of data.

### SUMMARY

To address the aforementioned and potentially other issues with currently available solutions, methods, systems, articles of manufacture, and the like consistent with one or more implementations of the current subject matter can, among other possible advantages, provide faster calculations of data using preaggregations and real-time processing.

In some aspects, a query can be calculated on all target data of a data warehouse with all variable combinations to generate a result, the result can be stored in a snapshot index associated with the data warehouse and recalculated to generate a subresult. The snapshot index can be updated with the subresult, and a conversion routine can be generated to recalculate the subresult into a separate table. A scheduler can recalculate the separate table by a background job to recalculate the subresult.

Implementations of the current subject matter can include, but are not limited to, systems and methods as described herein as well as articles that comprise a tangibly embodied (e.g. non-transitory) machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating aspects of a system showing features consistent with implementations of the current subject matter; and

FIG. 2 is a process flow diagram illustrating aspects of a method having one or more features consistent with implementations of the current subject matter;

When practical, similar reference numbers denote similar structures, features, or elements.

### DETAILED DESCRIPTION

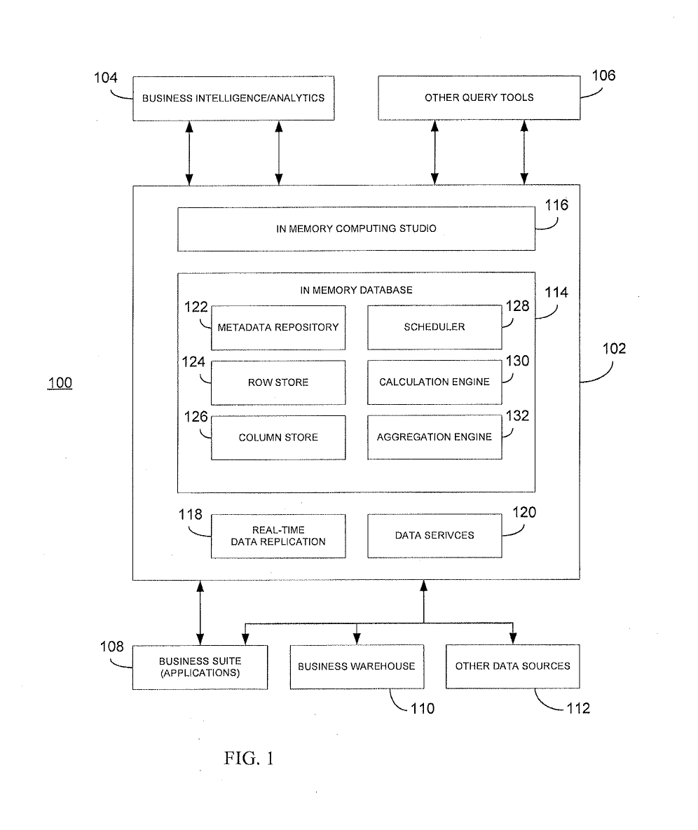

FIG. 1 is a block diagram of an exemplary real-time analytics and applications platform 100 consistent with features of the present subject matter. The platform 100 includes a data warehouse 102 for storing and processing massive amounts of data for business intelligence and analytics modules 104 and other query tools 106 such as search engines, etc. The platform 100 can also store and process data for one or more applications in a business suite 108, such as customer relationship management (CRM), enterprise resource planning (ERP), or other application, business warehouse applications 110, and other data sources 112.

The data warehouse 102 includes an in-memory computing studio 116 for modeling and administration functions of queries or requests received from the business intelligence and analytics modules 104 or other query tools. The data warehouse 102 further includes an in-memory database 114 that includes a metadata repository 122, a calculation engine 130 and an aggregation engine 132.

The in-memory database 114 also includes a scheduler 128 that generates a background job to start a calculation on data stored in the in-memory database 114, based on a request or query. The in-memory database 114 further includes a row store 124 and a column store 126, each being one of the relational engines. The row store 124 is interfaced with the calculation engine 130, and is a pure in-memory store. The column store 126 is also interfaced with the calculation engine 130, and is optimized for high performance of READ operations, and provides improvement over the row store 124 for data compression, for both main data and delta data.

Systems, processes, etc. consistent with implementations of the current subject matter can enable integration of preaggregations and real-time processing. In general, not every row in an aggregate is outdated when the underlying raw data changes. Accordingly, a concept of delta updates can be applied to more improve processing efficiency. Some data warehouse systems use a replication mechanism, which can also benefit from one or more of the fetaures described herein.

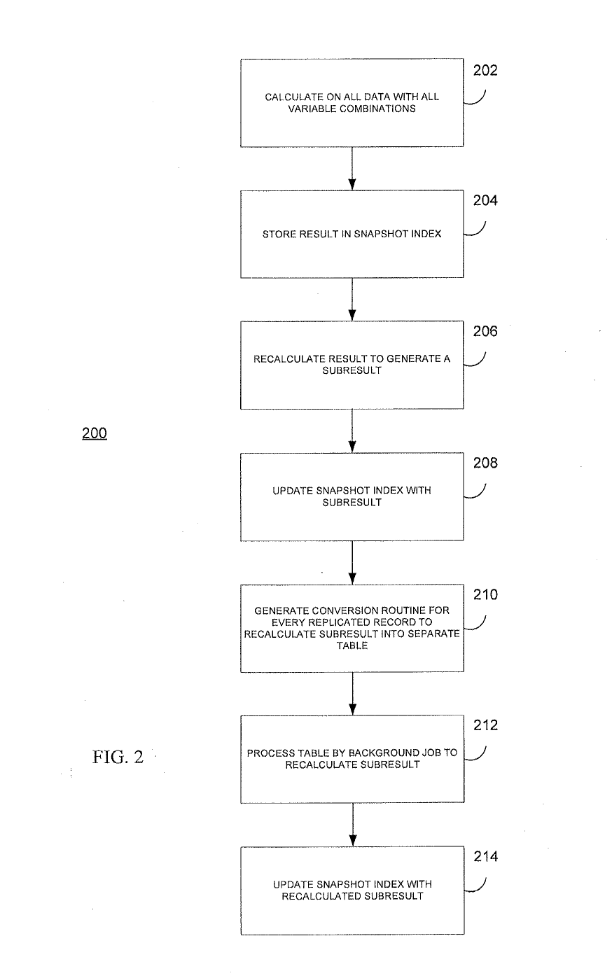

FIG. 2 shows a process flow chart 200 illustrating features consistent with one or more implementations of the current subject matter. For a calculation, for example a long running calculation on a very large data set that does not lend itself to real-time processing, calculations can be performed on all data with all variable combinations (input combination and procedure) at 202 and the result stored in a column table as a so-called snapshot index 204. The snapshot index is a table that enables any kind of reporting. The result can be recalculated, for example for all replicated records, to generate a subresult at 206, and the snapshot index table can be updated with the recalculated subresult at 208.

In an exemplary implementation, a system landscape transformation tool (SLT) can be applied as a default replication mechanism. In some examples, such a tool can be implemented in an application server based on a business programming language, such as for an Advanced Business Application Programming language application server (also referred to as ABAP AS).

At 210, a conversion routine can be generated, and this conversion routine can write the important information for the replicated records, for recalculating the updated subresult into a separate table. This table can be processed by a background job (scheduler) at 212, for example by starting a job with one entry of the table to recalculate the result within the in-memory database via a database shared library (DBSL) connection. The recalculated subresult can be updated within the snapshot index table at 214.

Using the techniques described above, an example calculation can be significantly accelerated, for example a processing time can be reduced from approximately 5 minutes to approximately 4 seconds. Thus, each reporting on the snapshot is 4 seconds+<time for replication>+<reporting time>=total time. Variability in available hardware, the complexity of a calculation, an amount of data, etc. can cause results to differ, but changes to the data in a system can be processed much more quickly using features discussed herein. For example, only a few seconds may be required for completion of complex calculations, as compared to 100-200 times that amount using previously available approaches.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer-implemented method comprising:
calculating, by at least one system comprising one or more processors, a query on all target data of a data warehouse with all variable combinations to generate a result;
storing, by the at least one system, the result in a snapshot index associated with the data warehouse;
recalculating, by the at least one system, the result to generate a subresult;
updating, by the at least one system, the snapshot index with the subresult;
generating, by the one or more processors, a conversion routine to recalculate the subresult into a separate table; and
recalculating, by the at least one system, the separate table by a background job to recalculate the subresult.

2. The method in accordance with claim 1, further comprising updating, by the at least one system, the snapshot index with the recalculated subresult.

3. The method in accordance with claim 1, wherein the background job is implemented by a scheduler associated with the data warehouse.

4. The method in accordance with claim 1, further comprising generating, by the one or more processors, at least one report using the recalculated subresult.

5. The method in accordance with claim 1, further comprising applying a system landscape transformation tool (SLT) as a default replication mechanism.

6. A non-transitory, computer-readable medium containing instructions to configure a processor to perform operations comprising:
calculating a query on all target data of a data warehouse with all variable combinations to generate a result;
storing the result in a snapshot index associated with the data warehouse;
recalculating the result to generate a subresult;
updating the snapshot index with the subresult;
generating a conversion routine to recalculate the subresult into a separate table; and
recalculating the separate table by a background job to recalculate the subresult.

7. The computer-readable medium in accordance with claim 6, wherein the operations further comprise updating the snapshot index with the recalculated subresult.

8. The computer-readable medium in accordance with claim 6, wherein the background job is implemented by a scheduler associated with the data warehouse.

9. The computer-readable medium in accordance with claim 6, wherein the operations further comprise generating at least one report using the recalculated subresult.

10. The computer-readable medium in accordance with claim 6, wherein the operations further comprise applying a system landscape transformation tool (SLT) as a default replication mechanism.

11. A system comprising:
at least one programmable processor; and
at least one computer-readable storage medium, the computer readable storage medium storing instructions that, when executed by the at least one programmable processor, cause the at least one programmable processor to perform operations comprising:
calculating a query on all target data of a data warehouse with all variable combinations to generate a result;
storing the result in a snapshot index associated with the data warehouse;
recalculating the result to generate a subresult;
updating the snapshot index with the subresult;
generating a conversion routine to recalculate the subresult into a separate table; and
recalculating the separate table by a background job to recalculate the subresult.

12. The system in accordance with claim 11, wherein the operations further comprise updating the snapshot index with the recalculated subresult.

13. The system in accordance with claim 11, wherein the background job is implemented by a scheduler associated with the data warehouse.

14. The system in accordance with claim 11, wherein the operations further comprise generating at least one report using the recalculated subresult.

15. The system in accordance with claim 11, wherein the operations further comprise applying a system landscape transformation tool (SLT) as a default replication mechanism.
